(19) United States
(12) Patent Application Publication
(10) Pub. No.: US 2024/0424877 A1
(43) Pub. Date: Dec. 26, 2024

(54) WEATHER STRIP

(71) Applicant: NISHIKAWA RUBBER CO., LTD., Hiroshima (JP)

(72) Inventors: Keigo MATSUMOTO, Hiroshima (JP); Katsunori NAKASHIMA, Hiroshima (JP); Yuichi NUIBE, Hiroshima (JP)

(21) Appl. No.: 18/747,808

(22) Filed: Jun. 19, 2024

(30) Foreign Application Priority Data
Jun. 24, 2023 (JP) 2023-103801

(51) Int. Cl. B60J 10/15; B60J 10/80

(52) U.S. Cl. CPC B60J 10/15; B60J 10/80

(57) ABSTRACT

A weather strip includes an installation base member and a hollow seal member. The installation base member couples to a flange of at least one of a peripheral edge of a panel of an automobile or a peripheral edge of an opening of an automobile body of the automobile. The hollow seal member is integrally molded with the installation base member, and makes elastic contact with the other one of the peripheral edge of the opening or the peripheral edge of the panel when the panel is in a closed position. The hollow seal member is formed by sponge rubber, and has a coating applied on the surface. The coating applied on the hollow seal member has a hardness of not less than 40.0 MPa.

### CROSS REFERENCE TO RELATED APPLICATION

This application claims the benefit under 35 USC § 119 of JP Patent Application 2023-103801 filed Jun. 24, 2023, the entire disclosure of which is incorporated herein by reference.

### BACKGROUND INFORMATION

The present invention relates to a weather strip that couples to a flange of at least one of a peripheral edge of a panel or a peripheral edge of an opening of an automobile body of an automobile. The panel includes, for example, a side door, a back door, a trunk lid, and a hood. When the panel is in a closed position, the weather strip seals a gap between the panel and the automobile body by making elastic contact with the automobile body or the panel.

A weather strip 100 illustrated in FIG. 7 has been used commonly. The weather strip 100 includes an installation base member 10 and a hollow seal member 20. The installation base member 10 couples to a flange of a peripheral edge of a panel 1, which is, for example, a door of the automobile. The hollow seal member 20 is integrally molded with the installation base member 10. The hollow seal member 20 makes elastic contact with a peripheral edge of an opening of an automobile body 2 of the automobile when the panel 1 is in the closed position. The hollow seal member 20 is formed by sponge rubber (see, for example, Japanese Patent No. 6470827).

Lowering density of a sponge rubber material of the weather strip 100, that is lowering specific gravity, reduces material for products, saves resources, and is environmentally friendly.

Lowering the specific gravity of the sponge rubber material, however, can increase sound that permeates through the hollow seal member 20 (hereinafter referred to as transmitted sound) toward the interior of the automobile from the exterior in conformance with the mass law.

Sponge rubber materials having a specific gravity that falls within a range of 0.45 to 0.70 have been used commonly as door weather strips formed by extrusion molding. As illustrated in FIG. 8, the sponge rubber material with a reduced specific gravity of 0.40 for weight reduction is inferior to the sponge rubber materials with the specific gravity of 0.53 and 0.54 in transmitted-sound reduction performance within a frequency of 2000 to 4000 Hz, which is influential to human ears.

The transmitted sound is reduced, for example, by increasing a thickness of the hollow seal member 20. This, however, increases compression load of the weather strip and deteriorates door closability, and is unfavorable.

Also, the transmitted sound is reduced by forming the hollow seal member by sponge material that has higher specific gravity or by solid rubber (see, for example, Japanese unexamined Patent Publication No. 10-236163). This, however, increases manufacturing cost due to increased number of materials and complicated configuration of dies used for extrusion molding as well as deteriorates the door closability due to the increased compression load compared with the hollow seal member formed by the ordinary sponge rubber material, and thus necessitates improvement.

To solve the above problems, it is an object of the present invention to provide a weather strip that is improved in transmitted-sound reduction effect.

### SUMMARY OF THE INVENTION

To achieve the above object, an aspect of the present invention provides a weather strip (200). The weather strip (200) includes an installation base member (10) and a seal member (20).

The installation base member (10) couples to a flange of at least one of a peripheral edge of a panel (1) of an automobile or a peripheral edge of an opening of an automobile body (2) of the automobile.

The seal member (20) is integrally molded with the installation base member (10). The seal member (20) makes elastic contact with the other one of the peripheral edge of the opening or the peripheral edge of the panel (1) when the panel (1) is in a closed position. The seal member (20) is formed by sponge rubber. The seal member (20) has a coating (50) applied on the surface. The seal member (20) has a hardness of not less than 40.0 MPa.

In addition, according to an aspect of the present invention, the sponge rubber has a specific gravity that falls within a range of 0.30 to 0.55.

In addition, according to an aspect of the present invention, the sponge rubber has a specific gravity that falls within a range of 0.40 to 0.55.

Another aspect of the present invention provides a weather strip (200). The weather strip (200) includes an installation base member (10) and a seal member (20).

The installation base member (10) couples to a flange of at least one of a peripheral edge of a panel (1) of an automobile or a peripheral edge of an opening of an automobile body (2) of the automobile.

The seal member (20) is integrally molded with the installation base member (10). The seal member (20) makes elastic contact with the other one of the peripheral edge of the opening or the peripheral edge of the panel (1) when the panel (1) is in a closed position. The seal member (20) is formed by sponge rubber. The seal member (20) has a coating (50) applied on the surface. The seal member (20) has a hardness that is found by a relational expression between the hardness of the seal member (20) and transmitted sound of the seal member (20). The seal member (20) has the hardness that reduces the transmitted sound by not less than 1 dB.

In addition, according to an aspect of the present invention, the seal member (20) has the hardness that is found by the relational expression between the hardness of the seal member (20) and the transmitted sound of the seal member (20), and the hardness is determined by nanoindentation technique.

Another aspect of the present invention provides a coating (50). The coating (50) is applied on the surface of a seal member (20) of a weather strip (200). The weather strip (200) includes an installation base member (10) and the seal member (20).

The installation base member (10) couples to a flange of at least one of a peripheral edge of a panel (1) of an automobile or a peripheral edge of an opening of an automobile body (2) of the automobile.

The seal member (20) is integrally molded with the installation base member (10). The seal member (20) makes elastic contact with the other one of the peripheral edge of the opening or the peripheral edge of the panel (1) when the panel (1) is in a closed position. The seal member (20) is formed by sponge rubber. The coating (50) as dried has a hardness of not less than 40.0 MPa.

Symbols in parentheses show constituents or items corresponding to the drawings.

According to the present invention, the weather strip includes the installation base member and the seal member. The installation base member couples to the flange of at least one of the peripheral edge of the panel or the peripheral edge of the opening. The seal member is integrally molded with the installation base member, makes elastic contact with the other one of the peripheral edge of the opening or the peripheral edge of the panel when the panel is in the closed position, is formed by sponge rubber, and has the coating applied on the surface. The seal member has the hardness of not less than 40.0 MPa. This achieves reduction of the transmitted sound of the seal member by not less than 1 dB.

Seal members with the coating merely for surface treatment have been used commonly. But this invention is distinguished because no related art has laid emphasis on the relation between the hardness of the seal member and the transmitted sound of the seal member. In addition, no related art has found the relation between the hardness of the seal member and the transmitted sound of the seal member on the basis of the relational expression illustrated in FIG. 3, or disclosed the seal member that has the hardness, hardness of paint coating in other words, of not less than 40.0 MPa, to achieve the reduction of the transmitted sound of the seal member by not less than 1 dB.

The sponge rubber material used as the seal member has the specific gravity that falls within the range of 0.30 to 0.55, within the range of 0.40 to 0.55 more preferably. The sponge rubber material having the specific gravity of not more than 0.40 reduces material for products, saves resources, and is environmentally friendly as well as reduces weight of the weather strip.

In addition, the hardness of the seal member is found by the relational expression between the hardness of the seal member and the transmitted sound of the seal member, and reduces the transmitted sound by not less than 1 dB. This reduces transmitted sound effectively.

In addition, nanoindentation technique is used to determine the hardness of the seal member precisely.

### BRIEF DESCRIPTION OF THE DRAWINGS

FIG. 1 is a cross-sectional view of a weather strip 200 according to an embodiment of the present invention.

FIG. 2 is a cross-sectional view of the weather strip 200 illustrated in FIG. 1 as bent.

FIG. 3 is a graph showing the relation between hardness (MPa) of a seal member and overall value (dB) of transmitted sound of the seal member.

FIG. 4 is a graph showing comparison of hardness of the seal members under the maximum indentation load of 100 μN of nanoindentation technique with the specific gravity of sponge rubber used as the seal members varied.

FIG. 5 is a graph showing comparison of hardness of the seal members under the maximum indentation load of 20 μN of nanoindentation technique with the specific gravity of sponge rubber used as the seal members varied.

FIG. 6 is a graph showing the relation between frequency and transmitted sound of sponge rubber having a specific gravity of 0.40 used as the seal member when the sponge rubber has a coating according to the embodiment of the present invention and when without the coating.

FIG. 7 is a cross-sectional view of a conventional weather strip 100 as bent.

FIG. 8 is a graph showing the relation between frequency and transmitted sound of the sponge rubber used as the seal member with the specific gravity of the sponge rubber varied.

### DETAILED DESCRIPTION

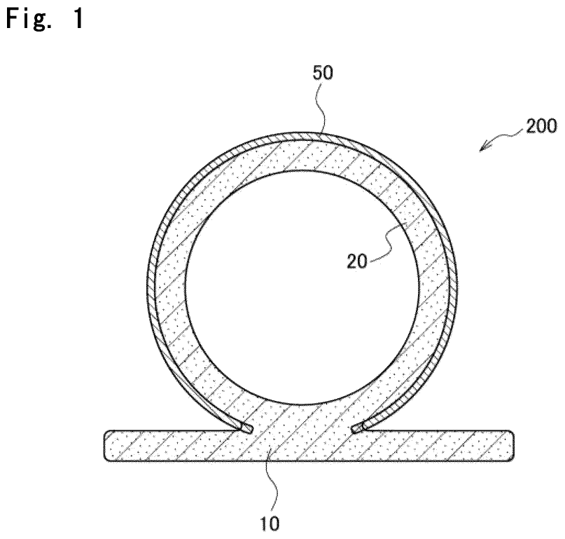

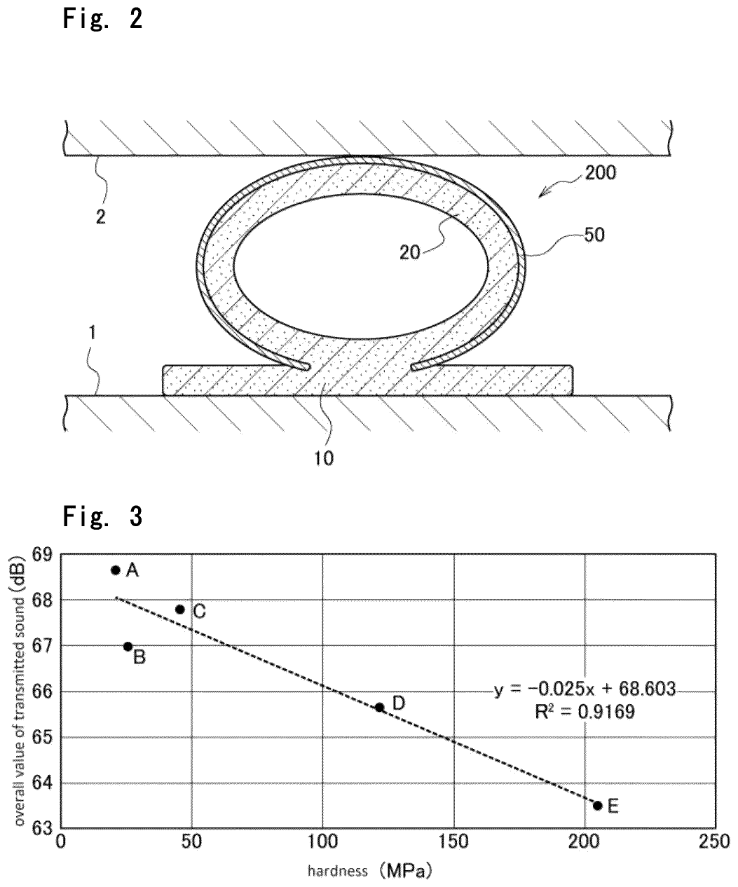

Referring to FIG. 1 and FIG. 2, a weather strip 200 according to an embodiment of the present invention will be described.

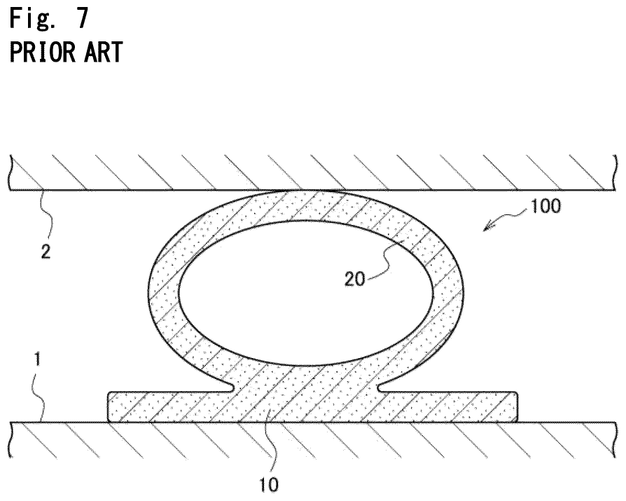

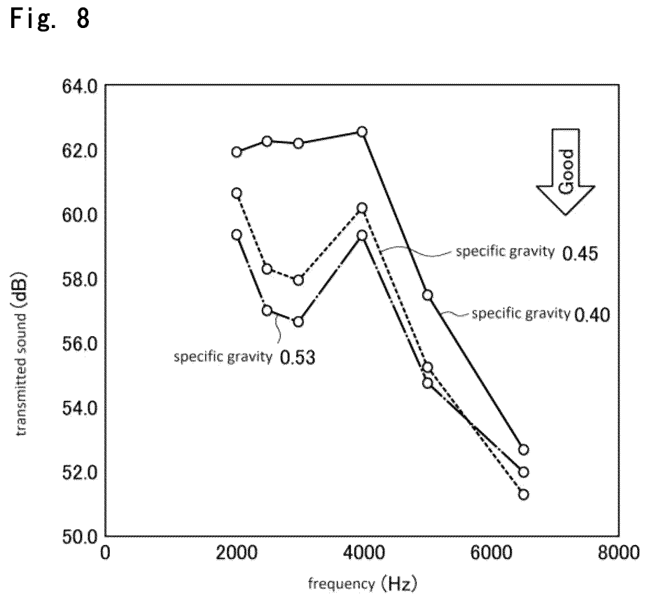

The weather strip 200 includes an installation base member 10 and a hollow seal member 20 in the same manner as a conventional weather strip 100 illustrated in FIG. 7. The installation base member 10 couples to a flange of a peripheral edge of a panel 1 of an automobile, which is a side door 1 in this embodiment. The hollow seal member 20 is integrally molded with the installation base member 10. The hollow seal member 20 makes elastic contact with a peripheral edge of a door opening of an automobile body 2 of the automobile when the side door 1 is in a closed position. The hollow seal member 20 is formed by sponge rubber. The hollow seal member 20 has a coating 50 applied on the surface.

When constituents or items correspond to those in the related art illustrated in FIG. 7, the same symbols are used.

The drawings illustrate a thickness of the coating 50 merely for better understanding of the invention. Actually, the coating 50 has the thickness expressed in micrometre (μm) and the hollow seal member 20 has the thickness expressed in millimeter (mm). The coating 50 has the thickness substantially one thousandth the thickness of the hollow seal member 20.

In this embodiment, the sponge rubber used as the hollow seal member 20 has the specific gravity of 0.40.

In this embodiment, the hollow seal member 20 is formed by a rubber material mainly including ethylene-propylene diene monomer (EPDM). In some embodiments, the hollow seal member 20 is formed by another rubber material mainly including synthetic rubber other than EPDM or thermoplastic elastomer.

In this embodiment, the coating 50, which keeps the hardness of the hollow seal member 20 not less than 40.0 MPa, is used to reduce transmitted sound of the hollow seal member 20 by not less than 1 dB.

The hollow seal member 20 has the hardness that is found by a relational expression illustrated in FIG. 3 between the hardness of the seal member 20 and overall value (dB), (2000 to 4000 Hz), of the transmitted sound of the hollow seal member 20.

FIG. 3 illustrates a solid line, which approximates to the values plotted between the hardness of the hollow seal members 20 and the corresponding overall values of transmitted sound of the hollow seal members 20. The solid line is created in Microsoft Excel (referred to Excel hereinafter). The hollow seal members 20 each have a sample coating A, B, C, D, E shown in Table 1 applied on the surface, and the hardness is determined by nanoindentation technique when the coating is dried.

The transmitted sound is measured by: fastening the weather strip 200 between two jigs not illustrated (fixing the weather strip 200 with a lower side jig and pressing an upper side jig against the weather strip 200, for example); making sound on a first side of the hollow seal member 20 (first side of a space between the two jigs); and collecting the sound on a second side of the hollow seal member 20 (second side of the space between the two jigs).

A relational expression of an approximate straight line is written as:
an approximate formula in Excel: y=−0.025x+68.603; and
coefficient of determination: R2=0.9169. This shows a close correlation between the transmitted sound of the hollow seal member 20 and the hardness of the hollow seal member 20.

TABLE 1

| sample | A | B | C | D | E |
|---|---|---|---|---|---|
| hardness (MPa) | 21.3 | 26.0 | 45.8 | 121.7 | 204.7 |
| overall value | 68.7 | 67.0 | 67.8 | 65.6 | 63.4 |
| 2000 to 4000 Hz | | | | | |
| (dB) | | | | | |

Nanoindentation technique is used to determine the hardness only with calculations on the basis of physical quantity (load and indentation depth) measured by a device. Nanoindentation technique is used to determine contact stiffness (stiffness) and contact depth, and to calculate the hardness and Young's modulus.

An indentation load (magnetic force) is generated by controlling the amount of current flowing through an electromagnetic coil, and then an indenter is pushed into the sample coating from above, to determine how far the samples displace, how easily the indenter is pressed into the samples in other words.

In this embodiment, the testing machine used as the nanoindentation tester is Anton Paar GmbH, UNIT 3, the indenter is Berkovich indenter, the maximum indentation load of the indenter is 20 μN, load or unload speed is 600 μN/min, and the test complies with ISO14577. The hollow seal member 20 is cut into a square 10 by 10 mm as a measurement sample. The measurement sample has a thickness of substantially 1.8 mm.

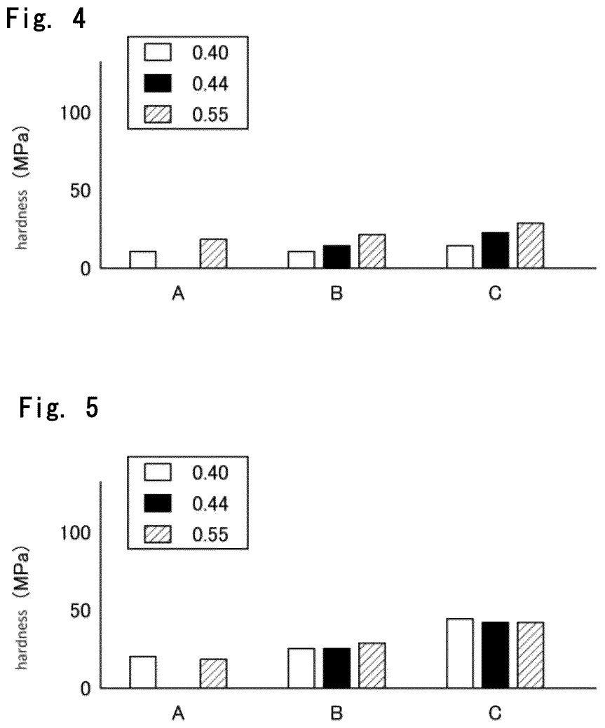

Under the maximum indentation load of the indenter of 100 μN, the specific gravity of the sponge rubber used as the hollow seal member 20 affects the hardness. This is evident from FIG. 4 where the hardness of the sponge rubber, which have the specific gravity of 0.40, 0.44, 0.55 and the same coating, widely varies. Under the maximum indentation load of the indenter of 20 μN as illustrated in FIG. 5, the specific gravity hardly affects the hardness, such that the hardness is determined precisely.

The relational expression (y=−0.025x+68.603) in FIG. 3 leads to 1 (=68.603-67.603)=0.025x, and x=40.0 MPa. This leads to 40.0 MPa as the hardness to reduce the transmitted sound of the hollow seal member 20 by 1 dB. In other words, the coating 50, which has the hardness of not less than 40.0 MPa, reduces the transmitted sound by not less than 1 dB.

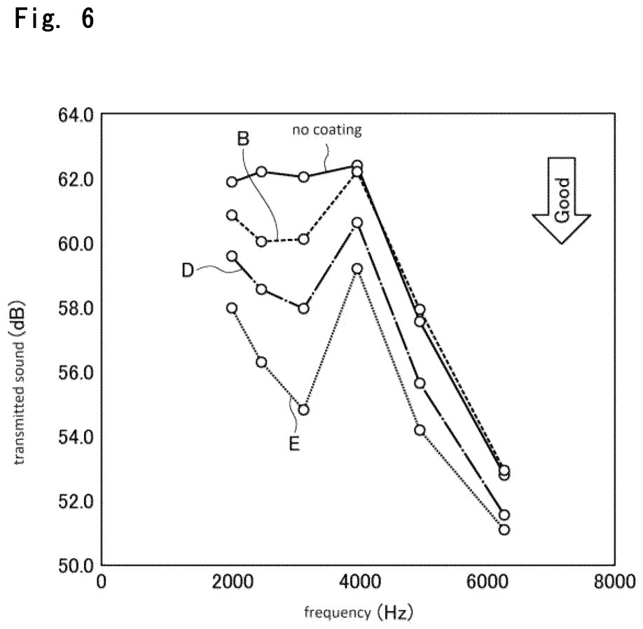

As illustrated in FIG. 6, applying samples B, D, E shown in Table 1 to the hollow seal members 20, formed by the sponge rubber having the specific gravity of 0.40, improves transmitted-sound reduction performance within a frequency of 2000 to 4000 Hz compared with the sponge rubber material having the specific gravity of 0.40 without the coating.

The hollow seal member 20 has the specific gravity of 0.40 for weight reduction and the hardness of 40.0 MPa. This achieves reduction of the transmitted sound of the hollow seal member 20 by not less than 1 dB.

The hollow seal member 20 with the coating merely for surface treatment has been used commonly. But this invention is distinguished because no related art has laid emphasis on the relation between the hardness of the hollow seal member 20 and the transmitted sound of the hollow seal member 20. In addition, no related art has found the relation between the hardness of hollow seal member 20 and the transmitted sound of the hollow seal member 20 on the basis of the relational expression illustrated in FIG. 3, or disclosed the hollow seal member 20, which has the hardness of not less than 40.0 MPa, to achieve the reduction of the transmitted sound of the hollow seal member 20 by not less than 1 dB.

In this embodiment, the hollow seal member 20 has the specific gravity of 0.40 for weight reduction and has the coating 50 applied on the surface. In some embodiments, the hollow seal member 20 is formed by a sponge rubber material having a specific gravity that falls within a range of 0.30 to 0.55, 0.40 to 0.55 more preferably, and has the coating 50 applied on the surface. This also reduces the transmitted sound of the hollow seal member 20 by not less than 1 dB.

In this embodiment, nanoindentation technique is used to determine the hardness of the hollow seal member 20 in finding the relational expression between the hardness of the seal member 20 and transmitted sound of the seal member 20. Also, the approximate formula created in Excel is used to calculate the relational expression between the hardness and the transmitted sound. In some embodiments, the hardness is determined by another technique, and the relational expression is calculated by another method.

In this embodiment, the weather strip 200 couples to the flange of the peripheral edge of the side door 1 and makes elastic contact with the peripheral edge of the door opening. In some embodiments, the weather strip 200 couples to the flange of the peripheral edge of the door opening and makes elastic contact with the peripheral edge of the side door 1 when the side door 1 is in the closed position. In some embodiments, the hollow seal member 20 is solid as lips. The weather strip 200 is applicable to every weather 10 strip, which couples to, for example, the flange of the panels of the automobiles, e.g., back doors, trunk lids, and hoods.

We claim:

1. A weather strip comprising:
an installation base member configured to be operably coupled to a flange of at least one of a peripheral edge of a panel of an automobile or a peripheral edge of an opening of an automobile body of the automobile; and
a seal member integrally molded with the installation base member, the seal member being configured to make elastic contact with the other one of the peripheral edge of the opening or the peripheral edge of the panel when the panel is in a closed position, the seal member being formed by sponge rubber, the seal member having a coating applied on the surface, and the seal member having a hardness of not less than 40.0 MPa.

2. The weather strip as claimed in claim 1, wherein
the sponge rubber has a specific gravity that falls within a range of 0.30 to 0.55.

3. The weather strip as claimed in claim 1, wherein
the sponge rubber has a specific gravity that falls within a range of 0.40 to 0.55.

4. A weather strip comprising:
an installation base member configured to be operably coupled to a flange of at least one of a peripheral edge of a panel of an automobile or a peripheral edge of an opening of an automobile body of the automobile; and
a seal member integrally molded with the installation base member, the seal member being configured to make elastic contact with the other one of the peripheral edge of the opening or the peripheral edge of the panel when the panel is in a closed position, the seal member being formed by sponge rubber, the seal member having a coating applied on the surface, the seal member having a hardness that is found by a relational expression between the hardness of the seal member and transmitted sound of the seal member, and the seal member having the hardness that reduces the transmitted sound by not less than 1 dB.

5. The weather strip as claimed in claim 4, wherein
the seal member has the hardness that is found by the relational expression between the hardness of the seal member and the transmitted sound of the seal member, and the hardness is determined by nanoindentation technique.

6. A coating applied on the surface of a seal member of a weather strip, the weather strip comprising:
an installation base member configured to be operably coupled to a flange of at least one of a peripheral edge of a panel of an automobile or a peripheral edge of an opening of an automobile body of the automobile; and
the seal member integrally molded with the installation base member, the seal member being configured to make elastic contact with the other one of the peripheral edge of the opening or the peripheral edge of the panel when the panel is in a closed position, and the seal member being formed by sponge rubber,
wherein the coating as dried has a hardness of not less than 40.0 MPa.
